(19) United States
(12) Patent Application Publication
(10) Pub. No.: US 2026/0149632 A1
(43) Pub. Date: May 28, 2026

(54) DOWNLINK CONFIGURATION FOR SUB-BAND DISCRETE FOURIER TRANSFORM

(71) Applicant: Lenovo (United States) Inc., Morrisville, NC (US)

(72) Inventors: Ali Ramadan ALI, Kraiburg am Inn (DE); Karthikeyan GANESAN, Nauheim (DE)

(21) Appl. No.: 18/962,988

(22) Filed: Nov. 27, 2024

(51) Int. Cl. H04L 27/26; H04L 5/00

(52) U.S. Cl. CPC H04L 27/2636; H04L 5/0039

(57) ABSTRACT

Various aspects of the present disclosure relate to a user equipment (UE) configured to, capable of, or operable to perform one or more operations as described herein. For example, the UE may be configured to, capable of, or operable to receive a first configuration for a group common search space associated with a plurality of UEs, the group common search space sharing common sub-band Discrete Fourier Transform (DFT) spreading for contiguous frequency domain resource blocks of a control channel, monitor the group common search space using parameters of the first configuration, and receive a second configuration within the group common search space, wherein the second configuration includes parameters for contiguous frequency domain resource blocks of a downlink data channel that share common sub-band DFT spreading.

### TECHNICAL FIELD

The present disclosure relates to wireless communications, and more specifically to Discrete Fourier Transform (DFT) spreading for control and data channels.

### BACKGROUND

A wireless communications system may include one or multiple network communication devices, otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive a first configuration for a group common search space associated with a plurality of UEs, the group common search space sharing common sub-band DFT spreading for contiguous frequency domain resource blocks of a control channel, monitor the group common search space using parameters of the first configuration, and receive a second configuration within the group common search space, wherein the second configuration includes parameters for contiguous frequency domain resource blocks of a downlink data channel that share common sub-band DFT spreading.

A processor (e.g., a standalone processor chipset, or a component of a UE) for wireless communication is described. The processor may be configured to, capable of, or operable to receive a first configuration for a group common search space associated with a plurality of UEs, the group common search space sharing common sub-band DFT spreading for contiguous frequency domain resource blocks of a control channel, monitor the group common search space using parameters of the first configuration, and receive a second configuration within the group common search space, wherein the second configuration includes parameters for contiguous frequency domain resource blocks of a downlink data channel that share common sub-band DFT spreading.

A method performed or performable by a UE for wireless communication is described. The method may include receiving a first configuration for a group common search space associated with a plurality of UEs, the group common search space sharing common sub-band DFT spreading for contiguous frequency domain resource blocks of a control channel, monitoring the group common search space using parameters of the first configuration, and receiving a second configuration within the group common search space, wherein the second configuration includes parameters for contiguous frequency domain resource blocks of a downlink data channel that share common sub-band DFT spreading.

In some implementations of the UE, the processor, and the method described herein, time domain control Channel Elements (CCEs) are concatenated within the group common search space, and a DFT length of the group common search space corresponds to an Aggregation Level (AL) of the group common search space.

In some implementations of the UE, the processor, and the method described herein, time domain CCEs are interleaved within the group common search space, and the first configuration comprises an interleaving depth.

In some implementations of the UE, the processor, and the method described herein, the UE, the processor, and the method may further be configured to, capable of, operable to decode Downlink Control Information (DCI) received in the group common search space using a group common Radio Network Temporary Identifier (RNTI).

In some implementations of the UE, the processor, and the method described herein, the UE, the processor, and the method may further be configured to, capable of, operable to receive a Control Resource Set (CORESET) for the plurality of UEs based on the first configuration, the CORESET comprising the group common search space, a Common Search Space (CSS), and at least one UE-specific Search Space (USS), wherein the group common search space and the CSS are encoded using a first waveform, and the at least one USS is encoded using a second waveform different from the first waveform.

In some implementations of the UE, the processor, and the method described herein, the first waveform is a Discrete Fourier Transform Spread Orthogonal Frequency Division Multiplexed (DFT-s-OFDM) waveform.

In some implementations of the UE, the processor, and the method described herein, the first configuration indicates a first DFT for the group common search space comprised in a CORESET for the plurality of UEs, and a second DFT different from the first DFT for at least one USS in the CORESET associated with at least one coverage limited UE, and the first DFT is frequency multiplexed with the second DFT in the CORESET.

In some implementations of the UE, the processor, and the method described herein, the first configuration indicates a single DFT used for the group common search space, a CSS, and at least one USS for at least one coverage-limited UE in a CORESET for the plurality of UEs.

In some implementations of the UE, the processor, and the method described herein, the first configuration further indicates at least one USS for which DFT precoding is disabled, and the at least one USS for which DFT precoding is disabled is associated with at least one UE with better coverage than the at least one coverage-limited UE.

In some implementations of the UE, the processor, and the method described herein, the first configuration indicates a fist DFT used for the group common search space, a second DFT used for a CSS, and a third DFT used for a USS in a CORESET for the plurality of UEs, and wherein the first, second and third DFTs are frequency multiplexed in the CORESET.

An NE (e.g., a base station) for wireless communication is described. The NE may be configured to, capable of, or operable to perform one or more operations as described herein. For example, the NE may be configured to, capable of, or operable to transmit a first configuration for a group common search space associated with a plurality of UEs, the group common search space sharing common sub-band DFT spreading for contiguous frequency domain resource blocks of a control channel, and transmit the group common search space, the group common search space comprising a second configuration which includes parameters for contiguous frequency domain resource blocks of a downlink data channel that share common sub-band DFT spreading.

A processor (e.g., a standalone processor chipset, or a component of an NE) for wireless communication is described. The processor may be configured to, capable of, or operable to transmit a first configuration for a group common search space associated with a plurality of UEs, the group common search space sharing common sub-band DFT spreading for contiguous frequency domain resource blocks of a control channel, and transmit the group common search space, the group common search space comprising a second configuration which includes parameters for contiguous frequency domain resource blocks of a downlink data channel that share common sub-band DFT spreading.

A method performed or performable by an NE (e.g., a base station) for wireless communication is described. The method includes transmitting a first configuration for a group common search space associated with a plurality of UEs, the group common search space sharing common sub-band DFT spreading for contiguous frequency domain resource blocks of a control channel, and transmitting the group common search space, the group common search space comprising a second configuration which includes parameters for contiguous frequency domain resource blocks of a downlink data channel that share common sub-band DFT spreading.

### BRIEF DESCRIPTION OF THE DRAWINGS

FIG. 1 illustrates an example of a wireless communications system in accordance with aspects of the present disclosure.

FIG. 2 illustrates an example of groups of UEs in accordance with aspects of the present disclosure.

FIG. 3 illustrates an example of applying a DFT to search spaces comprising control information in accordance with aspects of the present disclosure.

FIGS. 4A, 4B and 4C illustrate examples of using different waveforms for a group common CORESET in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of a NE in accordance with aspects of the present disclosure.

FIG. 8 illustrates a flowchart of method performed by a UE in accordance with aspects of the present disclosure.

FIG. 9 illustrates a flowchart of method performed by a NE in accordance with aspects of the present disclosure.

### DETAILED DESCRIPTION

In NR 5G, Cyclic Prefix-Orthogonal Frequency Division Multiplexing (CP-OFDM) based waveforms have been adopted for downlink (DL) as well as for uplink (UL), and Discrete Fourier Transform-Spread OFDM (DFT-s-OFDM) has been adopted for UL. DFT-s-OFDM is similar to single carrier frequency division multiple access (SC-FDMA) where each user or transmitter is allocated a single carrier and a finite portion of the channel bandwidth, and every user is separated from the adjacent users with a finite amount of spacing to prevent interference. DFT-s-OFDM eliminates the need for spacing between users and combines all the users orthogonally such that the peak of one user coincides with the null of other users. DFT is a technique that converts a discrete set of input signal sequences in the time domain into discrete components in the frequency domain.

CP-OFDM degrades power efficiency due to a high peak to average power ratio (PAPR) and the need for backoff at transmission which limits the achievable coverage. Network performance can be improved by extending DL coverage and energy savings. Adopting a low PAPR waveform such as DFT-s-OFDM for DL has the potential to achieve both network energy savings and improved coverage.

However, if the number of scheduled UEs in DL increases, the benefit of using conventional DFT-s-OFDM implementations (using multiple DFTs with shorter lengths) decreases since the improvement of PAPR reduction depends on the DFT length, which is correlated with the allocated resources for each UE in the carrier bandwidth. DFT-s-OFDM has been implemented in UL using a single DFT for each UE, and using multiple DFTs with shorter lengths since each UE transmits only its own resources. This restriction can be overcome in the case of DL since the base station can schedule the resources of multiple UEs and transmit a combined signal at the same time.

A single DFT spreading over the control resources (e.g. control channel elements (CCEs)) of multiple UEs can achieve lower PAPR compared to using an individual DFT for the CCEs of each UE, and in particular to using a different DFT for user-specific search spaces (USSs) for each UE. A configuration of a sub-band DFT based control channel for UEs sharing same DFT may be signaled to these UEs to implement the sub-band DFT based control channel. Embodiments of the present disclosure relate to the design and configuration of control channel common to plurality of UEs that share same sub-band DFT, which can improve coverage and save power in a telecommunications network.

Aspects of the present disclosure are described in the context of a wireless communications system.

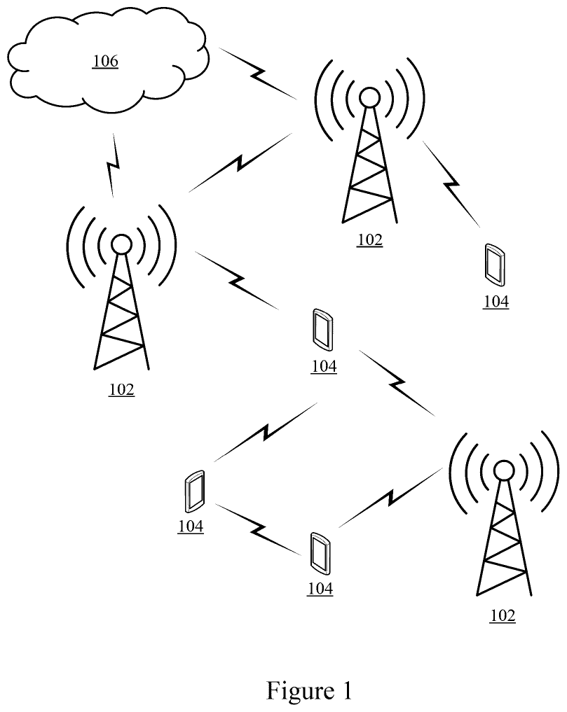

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0,μ=1,μ=2, μ=3,μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Existing solutions to enhancing the coverage of control information, especially common control information such as downlink control information (DCI), involve increasing the aggregation level (AL). Several ALs are defined in 5G, each of which corresponds to a number of control channel elements (CCEs) which are used for a control resource set (CORESET) that carries physical downlink control channel (PDCCH) DCI signaling. A CCE comprises six resource element groups (REGs), and each REG includes 12 resource elements (REs). Increasing the AL consumes more CCEs which would otherwise be available to other UEs in a slot, so increasing AL can reduce cell capacity. Conventional processes for receiving control information and determining PDCCH assignment are documented in TS38.213v18, the contents of which are incorporated by reference herein.

Embodiments of the present disclosure use DFT-s-OFDM waveforms in DL channels, and in particular in DL control channels, which can make more efficient use of limited spectrum than conventional ALs. DFT spreading may be performed for a group of UEs that share the same DFT sub-band to achieve a minimal PAPR and cubic metric (CM) of the PAPR. Instead of applying different DFTs for the control information of individual UEs, a single DFT may be applied to an entire CORESET, or at least to a portion of a CORESET that applies to a set or group of UEs.

For a NE 102 (e.g. a base station) to send the control information for a plurality of UEs 104 that share the same DFT sub-band for their physical downlink shared channel (PDSCH), embodiments may use a group common search space (GCSS) that is configured for a group of UEs to monitor the group common PDCCH.

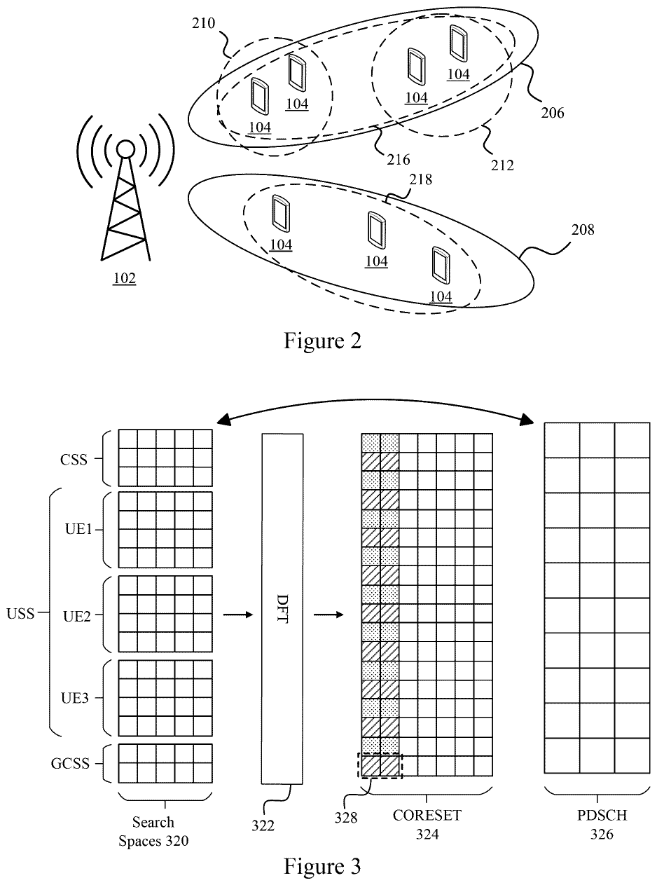

FIG. 2 illustrates an example of groups of UEs 104 in accordance with aspects of the present disclosure. FIG. 2 illustrates two examples of how UEs can be grouped to benefit from a sub-band DFT of both control and data channels. In FIG. 2, a first beam 206 is associated with four UEs 104, and a second beam 208 is associated with three different UEs 104. The beams 206 and 208 may be, for example, synchronization signal block (SSB) beams or serving beams.

Each set of UEs 104 associated with an individual beam 206/208 transmitted by NE 102 may be grouped together for purposes of sharing the same DFT sub-band for DL signaling. In some embodiments, the UEs 104 may be grouped according to the associated beam. For example, UEs 104 associated with beam 206 may be grouped in the same DFT group 216, and UEs associated with beam 208 may be grouped in the same DFT group 218.

In addition or in the alternative, UEs 104 may be grouped according to proximity to a serving base station, e.g. NE 102 in FIG. 2. UEs with a close proximity to the NE may be grouped together as indicated by a first (near) proximity group 210, and UEs with further proximity may be grouped together by a second (far) proximity group 212. Thus, a UE 104 may be grouped by one or both of their proximity to a serving base station (e.g. NE 102) and a beam (e.g. SSB beam or serving beam) associated with the UE.

In some embodiments, UEs 104 are configured with a first configuration for search spaces within a CORESET using a configuration message. For example, frequency and time domain resource information for a CORESET may be transmitted to a group of UEs 104 to which the CORESET applies using a radio resource control (RRC) message such as coresetConfig, to the group of UEs. The first configuration message may comprise information for receiving the CORESET, including the location and a length of one or more sub-band DFT of the CORESET.

The sub-band DFT length may be equal to or larger than the CORESET size. The sub-band DFT length (the DFT length) may be proportional to the number of RBs associated with the DFT. More specifically, the DFT length may correspond to the number of time domain modulated symbols or constellation points, and a DFT operation is applied to convert the time domain symbols or constellation points into discrete components in the frequency domain followed by an inverse fast Fourier transform (IFFT) operation applied on the entire carrier bandwidth, including other CORESETs, to generate the time domain signal for transmission.

Additional information for a GCSS may be present in a searchSpace information element (IE) within coresetConfig. The searchSpace IE may include information including an AL, monitoring symbols, periodicity, and a DCI format for a GCSS.

In an embodiment, a single DFT is performed on the time domain control information of a plurality of UEs 104 in DL to generate combined frequency domain resources for the UEs. FIG. 3 illustrates an example of applying a DFT to search spaces comprising control information in accordance with aspects of the present disclosure. As seen in FIG. 3, a DFT 322 is applied to a set of search spaces 320 including a common search space CSS, a user-specific search space USS comprising search spaces for a group of UEs (UE1, UE2 and UE3), and a group common search space GCSS to create a CORESET 324. The group of UEs 104 may be a group 216, 218, 210 or 212 as described above.

The CORESET 324 may include a demodulation reference signal (DMRS) 328 for some or all of the RBs in the CORESET. The DMRS 328 may be the same for all UEs 104 in a group associated with the CORESET 324 when all UEs use the same DFT 322, and may be used by the UEs to estimate the PDCCH.

The GCSS may comprise group common control information, e.g. group common DCI for a PDSCH 326. In particular, the group common control information may include parameters for receiving DL data for the group of UEs 104 (UE1, UE2 and UE3 in FIG. 3) that share a sub-band DFT for their PDSCH 326. Accordingly, the PDSCH 326 may be transmitted using DFT-s-OFDM, and the GCSS of search spaces 320 may comprise control information (e.g. DCI) for receiving the DFT-s-OFDM PDSCH 326.

In some embodiments, the control information of a GCSS in the time domain are mapped to REs before DFT spreading. In one implementation, time domain CCEs within a GCSS are concatenated to form a search space with a DFT length corresponding to an AL, after which DFT spreading is applied to the concatenated CCEs. The group of UEs (e.g. UE1, UE2 and UE3) may be configured with a starting symbol, RB offset and DFT length for receiving a group common PDCCH, e.g. a CORESET 324, with a configuration message from an NE 102.

In another implementation, time domain CCEs within a GCSS with the corresponding AL are interleaved prior to DFT spreading. In such an embodiment, a group of UEs may be configured with the starting symbol, RB offset, interleaving depth, and length of DFT for receiving a group common PDCCH, and in particular, a CORESET 324.

In still another implementation, a bit map of CCE-to-REG mapping parameters may be transmitted to a group of UEs 104 in a configuration message. In this implementation, the REGs may represent the time resources of one or more search space before DFT spreading.

In an embodiment, group common control information in a CORESET may be associated with a group specific radio network temporary identifier (RNTI). In particular, a cyclic redundancy prefix (CRC) of a group common DCI may be scrambled with a group common RNTI, e.g., a G-CS-RNTI. This control information may contain the parameters for receiving a PDSCH, e.g., a size of a sub-band DFT, time/frequency allocation of a sub-band PDSCH shared by a group of UEs, a group common DMRS for the shared PDSCH, a group common channel state information reference signal (CSI-RS), a group common phase tracking reference signal (PTRS), etc.

In some embodiments, different waveforms may be used for UE specific search spaces depending on the characteristics of the UEs. DFT spreading may only be performed on time domain control information for USSs of some UEs 104 in DL to generate combined frequency domain resources for the UEs. Accordingly, the CORESET 324 configured to UE(s) may be generated using mixed waveforms, e.g., CP-OFDM and DFT-s-OFDM.

For example, DFT spreading may be applied to USSs for UEs 104 with limited coverage, and DFT spreading may be disabled or otherwise not applied to USSs for UEs with good coverage. The classification of UE coverage-whether a UE 104 has limited coverage or good coverage-may be made by an NE 102 based on characteristics of the UE.

For example, the NE 102 may use a signal strength metric such as reference signal received power (RSRP) or signal to interference plus noise ratio (SINR) to determine whether a UE 104 has good coverage or limited coverage by comparing the signal strength metric to a threshold value. When the signal strength metric is greater than (or possibly equal to) the threshold value, the UE 104 may be classified as having good coverage, and when the signal strength is less than (or possibly equal to) the threshold value, the UE may be classified as a coverage limited UE. In another embodiment, the NE 102 may use a different metric such as position measurement for this classification. Persons of skill in the art will recognize that numerous alternatives are possible for classifying a UE 104 as having good coverage or limited coverage.

In such embodiments, CSS and GCSS for a group of UEs 104 with limited coverage may be generated using DFT-s-OFDM by enabling transform precoding on the corresponding CCEs, while multiple waveforms are used to generate USSs for UEs with good coverage.

For UEs 104 with good proximity to the serving base station (NE 102), the transform precoding may be disabled, for which the CCEs within the USS of a plurality of UEs are mapped directly in frequency grid prior to performing an IFFT. For UEs 104 with limited coverage, the transform precoding may be enabled, for which the CCEs within the USS of plurality of UEs are spread with a single DFT before mapping to frequency grid.

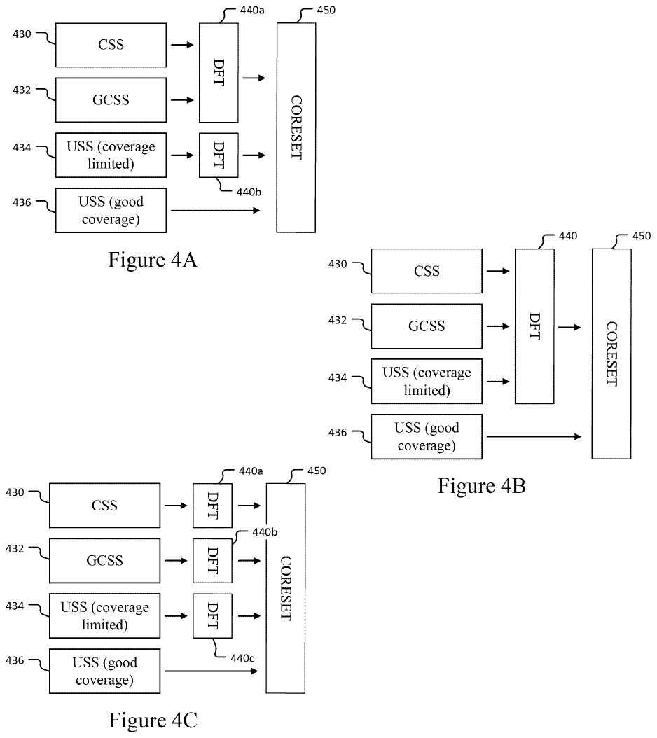

FIGS. 4A, 4B and 4C illustrate respective examples of using different waveforms for a group common CORESET 450 in accordance with aspects of the present disclosure. In an embodiment, UEs 104 are configured with a number of DFTs 440 and the search spaces to which each DFT is applied by a NE 102 using a first configuration message, e.g. a coresetConfig message.

In the embodiment of FIG. 4A, two different DFTs are applied within a CORESET 450. A CSS 430 and GCSS 432 are spread with a first DFT 440a, and a USS 434 for coverage limited UEs 104 are spread with a second DFT 440b. No DFT is applied to the USS 436 for UEs 104 with good coverage, e.g. UEs with a coverage metric that is greater than (or possibly equal to) a threshold value. Accordingly, the CORESET 450 is frequency division multiplexed with two DFTs (440a and 440b). The CORESET may be transmitted by the NE 102 using DFT-s-OFDM waveforms for the CSS 430, GCSS 432, and USS 434 for coverage limited UE portions of the CORESET 450, and a CP-OFDM waveform for the USS 436 for good coverage UEs portions of the CORESET 450.

In the embodiment of FIG. 4B, a single DFT 440 is applied to the CSS 430, GCSS 432, and USS 434 for coverage limited UEs, and transform precoding is disabled for the USS 436 for UEs with good coverage to create a CORESET 450 with mixed waveforms.

In the embodiment of FIG. 4C, separate DFTs are applied to respective search spaces. In particular, a first DFT 440a is applied to CSS 430, a second DFT 440b is applied to GCSS 432, and a third DFT 440c is applied to USS 434 for coverage limited UEs. Transform precoding is disabled for the USS 436 for UEs with good coverage.

In view of the foregoing examples, it is apparent that multiple different embodiments of applying different waveforms to search spaces are possible. The specific implementation of the mixed waveforms, e.g. the examples of FIGS. 4A, 4B and 4C, may be applied based on one or more factor such as a desired coverage, the size and the available resources for the control information, and the channel conditions.

In some embodiments, group common information for a plurality of UEs 104 sharing a same sub-band DFT for PDSCH may be sent as part of group common signaling within a CSS. That is, instead of using a discrete GCSS for transmitting a configuration to a group of UEs 104 for a group common DFT spread PDSCH, a configuration for receiving the PDSCH (e.g. a second configuration) may be transmitted to the UEs using a CSS.

In some implementations, a new PDCCH type is defined, e.g., a Type4-PDCCH, in which group common information for a sub-band DFT is transmitted to a plurality of UEs 104. A Type4-PDCCH CSS set may be configured by the SearchSpace IE in PDCCH-Config with searchSpaceType=common for DCI formats with a CRC scrambled by a sub-band DFT specific RNTI, e.g., a DFT-RNTI.

In other implementations, a Type3-PDCCH is used to signal group common information for a plurality of UEs 104 sharing the same sub-band DFT for PDSCH. A Type3-PDCCH CSS set may be configured by the SearchSpace IE in the PDCCH-Config message with searchSpaceType=common for DCI formats with CRCs scrambled by DFT-RNTI, INT-RNTI, SFI-RNTI, TPC-PUSCH-RNTI, TPC-PUCCH-RNTI, TPC-SRS-RNTI, or CI-RNTI.

If a UE 104 monitors PDCCH candidates for DCI formats with a CRC scrambled by a DFT-RNTI and the UE is provided with a non-zero value for searchSpaceID in PDCCH-ConfigCommon for a Type3/4-PDCCH CSS set, the UE may determine monitoring occasions for PDCCH candidates of the Type3/4-PDCCH CSS set based on the search space set associated with the value of searchSpaceID.

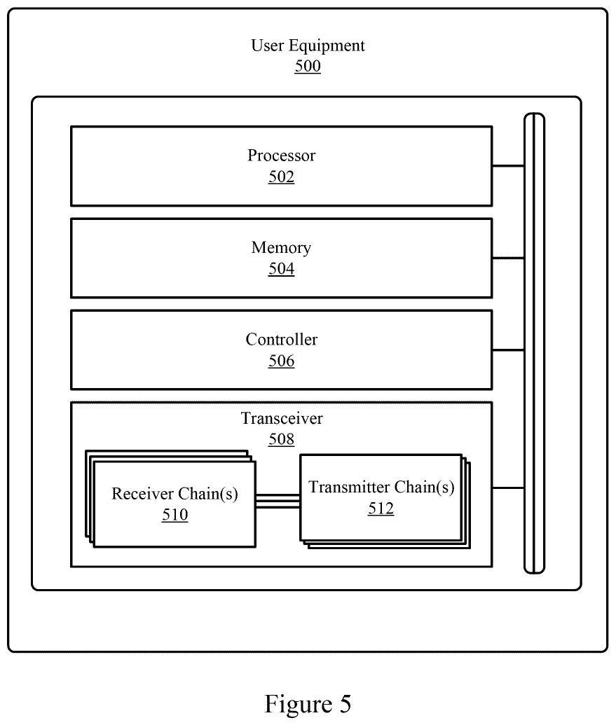

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to support a means for receiving a first configuration for a group common search space associated with a plurality of UEs, the group common search space sharing common sub-band Discrete Fourier Transform (DFT) spreading for contiguous frequency domain resource blocks of a control channel, monitoring the group common search space using parameters of the first configuration, and receiving a second configuration within the group common search space, wherein the second configuration includes parameters for contiguous frequency domain resource blocks of a downlink data channel that share common sub-band DFT spreading.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

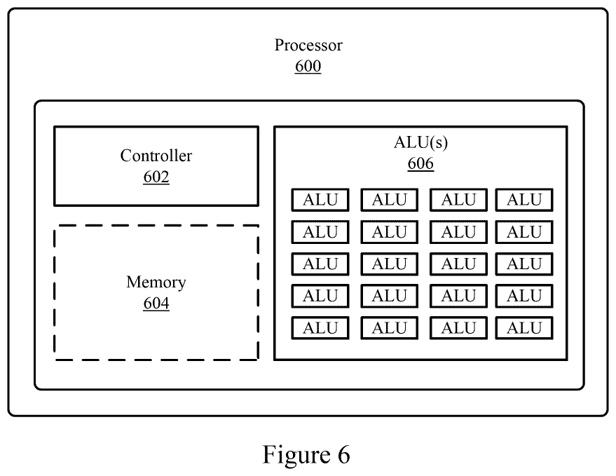

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support a means for receiving a first configuration for a group common search space associated with a plurality of UEs, the group common search space sharing common sub-band Discrete Fourier Transform (DFT) spreading for contiguous frequency domain resource blocks of a control channel, monitoring the group common search space using parameters of the first configuration, and receiving a second configuration within the group common search space, wherein the second configuration includes parameters for contiguous frequency domain resource blocks of a downlink data channel that share common sub-band DFT spreading.

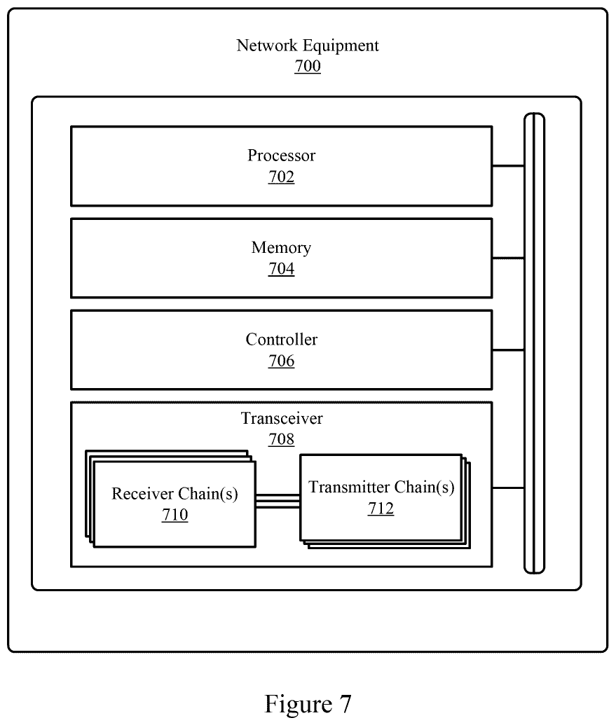

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to support a means for transmitting a first configuration for a group common search space associated with a plurality of UEs, the group common search space sharing common sub-band DFT spreading for contiguous frequency domain resource blocks of a control channel, and transmitting the group common search space, the group common search space comprising a second configuration which includes parameters for contiguous frequency domain resource blocks of a downlink data channel that share common sub-band DFT spreading.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or a wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

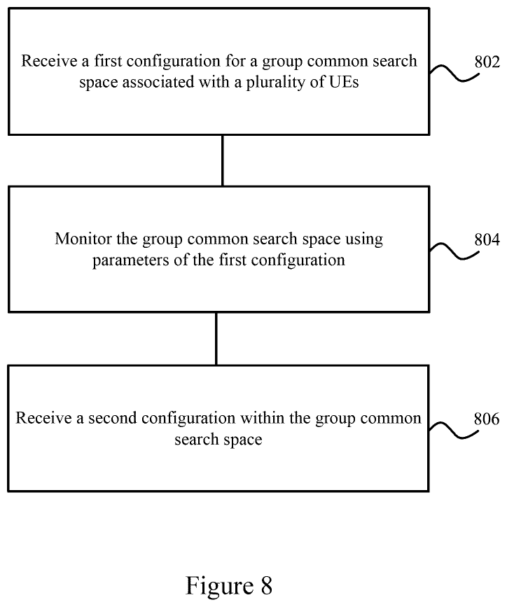

FIG. 8 illustrates a flowchart of a method in accordance with aspects of the present disclosure. The operations of the method may be implemented by a UE as described herein. In some implementations, the UE may execute a set of instructions to control the function elements of the UE to perform the described functions.

At 802, the method may include receiving a first configuration for a group common search space associated with a plurality of UEs. The operations of 802 may be performed in accordance with examples as described herein. In some implementations, aspects of the operations of 802 may be performed by a UE as described with reference to FIG. 5.

At 804, the method may include monitoring the group common search space using parameters of the first configuration. The operations of 804 may be performed in accordance with examples as described herein. In some implementations, aspects of the operations of 804 may be performed by a UE as described with reference to FIG. 5.

At 806, the method may include receiving a second configuration within the group common search space. The operations of 806 may be performed in accordance with examples as described herein. In some implementations, aspects of the operations of 806 may be performed a UE as described with reference to FIG. 5.

It should be noted that the method described herein describes a possible implementation, and that the operations and the steps may be rearranged or otherwise modified and that other implementations are possible.

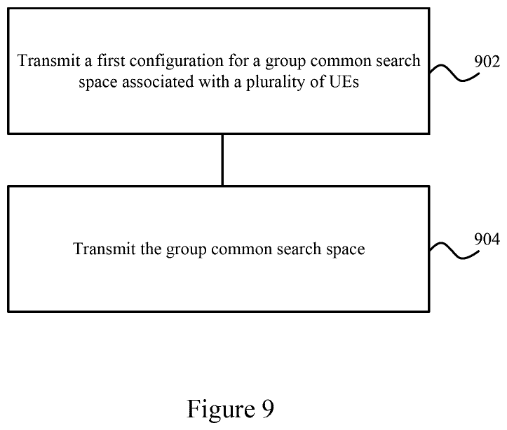

FIG. 9 illustrates a flowchart of a method in accordance with aspects of the present disclosure. The operations of the method may be implemented by a NE as described herein. In some implementations, the NE may execute a set of instructions to control the function elements of the NE to perform the described functions.

At 902, the method may include transmitting a first configuration for a group common search space associated with a plurality of UEs. The operations of 902 may be performed in accordance with examples as described herein. In some implementations, aspects of the operations of 902 may be performed by a NE as described with reference to FIG. 7.

At 904, the method may include transmitting the group common search space. The operations of 904 may be performed in accordance with examples as described herein. In some implementations, aspects of the operations of 904 may be performed by a NE as described with reference to FIG. 7.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a first configuration for a group common search space associated with a plurality of UEs, the group common search space sharing common sub-band Discrete Fourier Transform (DFT) spreading for contiguous frequency domain resource blocks of a control channel;
monitor the group common search space using parameters of the first configuration; and
receive a second configuration within the group common search space, wherein the second configuration includes parameters for contiguous frequency domain resource blocks of a downlink data channel that share common sub-band DFT spreading.

2. The UE of claim 1, wherein time domain control Channel Elements (CCEs) are concatenated within the group common search space, and a DFT length of the group common search space corresponds to an Aggregation Level (AL) of the group common search space.

3. The UE of claim 1, wherein time domain CCEs are interleaved within the group common search space, and the first configuration comprises an interleaving depth.

4. The UE of claim 1, wherein the at least one processor is further configured to cause the UE to:
decode Downlink Control Information (DCI) received in the group common search space using a group common Radio Network Temporary Identifier (RNTI) associated with a DFT group.

5. The UE of claim 1, wherein the at least one processor is further configured to cause the UE to:
receive a Control Resource Set (CORESET) for the plurality of UEs based on the first configuration, the CORESET comprising the group common search space, a Common Search Space (CSS), and at least one UE-specific Search Space (USS),
wherein the group common search space and the CSS are encoded using a first waveform, and the at least one USS is encoded using a second waveform different from the first waveform.

6. The UE of claim 5, wherein the first waveform is a Discrete Fourier Transform Spread Orthogonal Frequency Division Multiplexed (DFT-s-OFDM) waveform.

7. The UE of claim 1, wherein the first configuration indicates a first DFT for the group common search space comprised in a CORESET for the plurality of UEs, and a second DFT different from the first DFT for at least one USS in the CORESET associated with at least one coverage limited UE, and
wherein the first DFT is frequency multiplexed with the second DFT in the CORESET.

8. The UE of claim 1, wherein the first configuration indicates a single DFT used for the group common search space, a CSS, and at least one USS for at least one coverage-limited UE in a CORESET for the plurality of UEs.

9. The UE of claim 8, wherein the first configuration further indicates at least one USS for which DFT precoding is disabled, and
wherein the at least one USS for which DFT precoding is disabled is associated with at least one UE with better coverage than the at least one coverage-limited UE.

10. The UE of claim 1, wherein the first configuration indicates a fist DFT used for the group common search space, a second DFT used for a CSS, and a third DFT used for a USS in a CORESET for the plurality of UEs, and
wherein the first, second and third DFTs are frequency multiplexed in the CORESET.

11. A processor for wireless communication, comprising:
at least one controller coupled with at least one memory and configured to cause the processor to:
receive a first configuration for a group common search space associated with a plurality of User Equipment (UEs), the group common search space sharing common sub-band Discrete Fourier Transform (DFT) spreading for contiguous frequency domain resource blocks of a control channel; and
receive a second configuration within the group common search space, wherein the second configuration includes parameters for contiguous frequency domain resource blocks of a downlink data channel that share common sub-band DFT spreading.

12. The processor of claim 11, wherein time domain control Channel Elements (CCEs) are concatenated within the group common search space, and a DFT length of the group common search space corresponds to an Aggregation Level (AL) of the group common search space.

13. The processor of claim 11, wherein time domain CCEs are interleaved within the group common search space, and the first configuration comprises an interleaving depth.

14. The processor of claim 11, wherein the at least one controller is further configured to cause the processor to:
decode Downlink Control Information (DCI) received in the group common search space using a group common Radio Network Temporary Identifier (RNTI) associated with a DFT group.

15. The processor of claim 11, wherein the at least one controller is further configured to cause the processor to:
receive a Control Resource Set (CORESET) for the plurality of UEs based on the first configuration, the CORESET comprising the group common search space, a Common Search Space (CSS), and at least one UE-specific Search Space (USS),
wherein the group common search space and the CSS are encoded using a first waveform, and the at least one USS is encoded using a second waveform different from the first waveform.

16. The processor of claim 15, wherein the first waveform is a Discrete Fourier Transform Spread Orthogonal Frequency Division Multiplexed (DFT-s-OFDM) waveform.

17. A base station for wireless communication, comprising:
at least one memory; and
at least one processor coupled with the at least one memory and configured to cause the base station to:
transmit a first configuration for a group common search space associated with a plurality of User Equipment (UEs), the group common search space sharing common sub-band Discrete Fourier Transform (DFT) spreading for contiguous frequency domain resource blocks of a control channel; and
transmit the group common search space, the group common search space comprising a second configuration which includes parameters for contiguous frequency domain resource blocks of a downlink data channel that share common sub-band DFT spreading.

18. The base station of claim 17, wherein time domain Control Channel Elements (CCEs) are concatenated within the group common search space, and a DFT length of the group common search space corresponds to an Aggregation Level (AL) of the group common search space.

19. The base station of claim 17, wherein time domain CCEs are interleaved within the group common search space, and the first configuration comprises an interleaving depth.

20. The base station of claim 17, wherein the at least one processor is further configured to cause the base station to:
transmit a Control Resource Set (CORESET) to the plurality of UEs based on the first configuration, the CORESET comprising the group common search space, a Common Search Space (CSS), and at least one UE-specific Search Space (USS),
wherein the group common search space and CSS are transmitted using a first waveform, and the at least one USS is transmitted using a second waveform different from the first waveform.
